(19) United States
(12) Patent Application Publication
(10) Pub. No.: US 2025/0070297 A1
(43) Pub. Date: Feb. 27, 2025

(54) ENERGY STORAGE CABINET

(71) Applicant: DELTA ELECTRONICS, INC., Taoyuan City (TW)

(72) Inventors: Chin-Ming CHEN, Taoyuan City (TW); Chih-Yu WU, Taoyuan City (TW); Yen-Kai PENG, Taoyuan City (TW)

(21) Appl. No.: 18/813,034

(22) Filed: Aug. 23, 2024

Related U.S. Application Data
(60) Provisional application No. 63/534,181, filed on Aug. 23, 2023.

(51) Int. Cl. H01M 10/613; H01M 10/627; H01M 10/6561; H01M 50/204; H01M 50/251

(52) U.S. Cl. CPC H01M 10/613; H01M 10/627; H01M 10/6561; H01M 50/204; H01M 50/251

(57) ABSTRACT

An energy storage cabinet includes a frame supporting multiple battery packs and a cooling device. The frame includes a support with a pipe and a partition dividing an internal fluid passage of the pipe into a first flow channel and a second flow channel. Each battery pack has a first vent and a second vent. The second vent of a first battery pack is in communication with the second flow channel. The first vent of a second battery pack is in communication with the first flow channel. The cooling device produces a cool air entering the first vent of the first battery pack and the first flow channel. As the cool air passes through the first battery pack, the cool air is heated and becomes a warm air, which is then discharged into the second flow channel through the second vent.

### RELATED APPLICATIONS

This application claims priority to U.S. Provisional Application Ser. No. 63/534,181, filed Aug. 23, 2023, which is herein incorporated by reference in its entirety.

### BACKGROUND

### Technical Field

The present disclosure relates to an energy storage cabinet.

### Description of Related Art

Power storage equipment typical includes multiple batteries. In order to keep the temperatures of the batteries within an appropriate operating temperature range, power storage equipment should be provided with a temperature control mechanism.

### SUMMARY

In view of the foregoing, one of the objects of the present disclosure is to provide an improved energy storage cabinet which can uniformly cool the included battery packs, such that the temperature of the energy storage cabinet can be effectively controlled.

To achieve the objective stated above, in accordance with an embodiment of the present disclosure, an energy storage cabinet includes a frame, a plurality of battery packs and a cooling device. The frame includes a first support. The first support includes a pipe and a partition. The pipe has a first internal fluid passage. The partition is disposed in the pipe and divides the first internal fluid passage into at least one first flow channel and a second flow channel. The battery packs are disposed on the frame and each includes a housing and a plurality of battery cells disposed in the housing. The housing has at least one first vent and a second vent. The battery packs include at least one first battery pack and at least one second battery pack positioned on two opposite sides of the first support. The second vent of the first battery pack communicates with the second flow channel. The first vent of the second battery pack communicates with the first flow channel. The cooling device is configured to produce a cool air. The cool air is configured to enter the first vent of the first battery pack and the first flow channel of the first support. As the cool air passes through the first battery pack, the cool air is heated and becomes a warm air. The warm air is then discharged into the second flow channel of the first support through the second vent of the first battery pack.

In one or more embodiments of the present disclosure, the partition has two lateral edges and a central portion. The two lateral edges and the central portion are fixedly attached to an inner wall of the pipe.

In one or more embodiments of the present disclosure, the inner wall of the pipe has a first wall portion and a second wall portion opposite to the first wall portion. The two lateral edges of the partition are fixedly attached to the first wall portion. The central portion of the partition is fixedly attached to the second wall portion.

In one or more embodiments of the present disclosure, the at least one first flow channel includes two flow channels located on two sides of the central portion of the partition. The at least one first vent of the second battery pack includes two vents communicating with the two flow channels, respectively.

In one or more embodiments of the present disclosure, the partition is bent into a stepped shape between the central portion and the two lateral edges.

In one or more embodiments of the present disclosure, the first support extends substantially vertically. The at least one first battery pack and the at least one second battery pack are plural in number and are stacked along the first support. The second vent of each of the first battery packs communicates with the second flow channel of the first support. The first vent of each of the second battery packs communicates with the first flow channel of the first support.

In one or more embodiments of the present disclosure, the frame further includes a second support and a cool air duct. The first battery pack is positioned between the first support and the second support. The second support has a second internal fluid passage communicating with the first vent of the first battery pack. The cool air duct is connected to a cool air output port of the cooling device, the first flow channel of the first support, and the second support.

In one or more embodiments of the present disclosure, the frame further includes a third support and a warm air duct. The second battery pack is positioned between the first support and the third support. The third support has a third internal fluid passage communicating with the second vent of the second battery pack. The warm air duct is connected to a warm air input port of the cooling device, the second flow channel of the first support, and the third support to guide the warm air to return to the cooling device.

In one or more embodiments of the present disclosure, the battery packs are stacked along a vertical direction and are arranged into multiple stacks. One of the cool air duct and the warm air duct extends above the battery packs, and another one of the cool air duct and the warm air duct extends underneath the battery packs.

In one or more embodiments of the present disclosure, the cooling device is positioned on a lateral side of the battery packs. The cool air duct and the warm air duct extend substantially horizontally to the lateral side of the battery packs and are connected to the cooling device.

In one or more embodiments of the present disclosure, the first battery pack further includes a first duct structure surrounding the second vent. The pipe of the first support has a side opening communicating with the second flow channel. The first support further comprises a second duct structure surrounding the side opening and being coupled to the first duct structure. The first duct structure has a first sloping edge. The second duct structure has a second sloping edge. The first sloping edge and the second sloping edge have complementary shapes and abut against each other.

In one or more embodiments of the present disclosure, the second battery pack further includes a first duct structure surrounding the first vent. The pipe of the first support has a side opening communicating with the first flow channel. The first support further includes a second duct structure surrounding the side opening and being coupled to the first duct structure. The first duct structure has a first sloping edge. The second duct structure has a second sloping edge. The first sloping edge and the second sloping edge have complementary shapes and abut against each other.

In one or more embodiments of the present disclosure, the energy storage cabinet further includes a heat insulating member covering an upper side of the battery packs.

In one or more embodiments of the present disclosure, the heat insulating member includes at least one of a liquid tank and a heat insulating plate.

In accordance with an embodiment of the present disclosure, an energy storage cabinet includes a frame, as well as a plurality of battery packs, a cooling device and a liquid tank disposed on the frame. The battery packs and the cooling device are connected to the ducts. The cooling device is configured to produce a cool air. The cool air is circulated in the ducts and the battery packs to facilitate cooling of the battery packs. The liquid tank covers an upper side of the battery packs and part or all of the ducts.

In one or more embodiments of the present disclosure, the frame further includes a plurality of main supports. The main supports are positioned on an outer side the battery packs and are spaced apart from the battery packs, such that ventilation spaces are created on the outer side of the battery packs.

In sum, in the energy storage cabinet of the present disclosure, one or more supports of the frame are hollow structures. The hollow supports can act as fluid passages and communicate with the internal space of the battery packs. The supports and the battery packs thus collectively form a small confined space. Airflow output by the cooling device of the energy storage cabinet can be circulated in the small confined space to facilitate temperature control of the battery packs. On the other hand, conventional energy storage cabinets typically use air conditioner to control the temperature of the entire internal space of the cabinet. The conventional approach results in higher power consumption of the air conditioner, and moreover, requires the energy storage cabinet to be equipped with air conditioner of higher cooling capacity. Furthermore, a partition is provided inside the support. The partition divides the internal fluid passage of the support into a cool air channel and a warm air channel, such that the support can transport cool air and warm air at the same time without mixing the cool air and the warm air. This technique can help the cooling device save power, and can make the temperatures of the battery packs of the energy storage cabinet more uniform as well.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates a side view of an energy storage cabinet in accordance with an embodiment of the present disclosure;

FIG. 2 illustrates a schematic view of one of the battery packs of the energy storage cabinet shown in FIG. 1;

FIG. 3 illustrates a partially enlarged view of the slots of the energy storage cabinet shown in FIG. 1;

FIG. 4 illustrates a sectional view of the energy storage cabinet shown in FIG. 1 taken along the line segment 4-4′;

FIG. 5 illustrates a sectional view of the energy storage cabinet shown in FIG. 1 taken along the line segment 5-5′;

FIG. 6 illustrates a sectional view of the energy storage cabinet shown in FIG. 1 taken along the line segment 6-6′; and

FIG. 7 illustrates a side view of an energy storage cabinet in accordance with another embodiment of the present disclosure.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

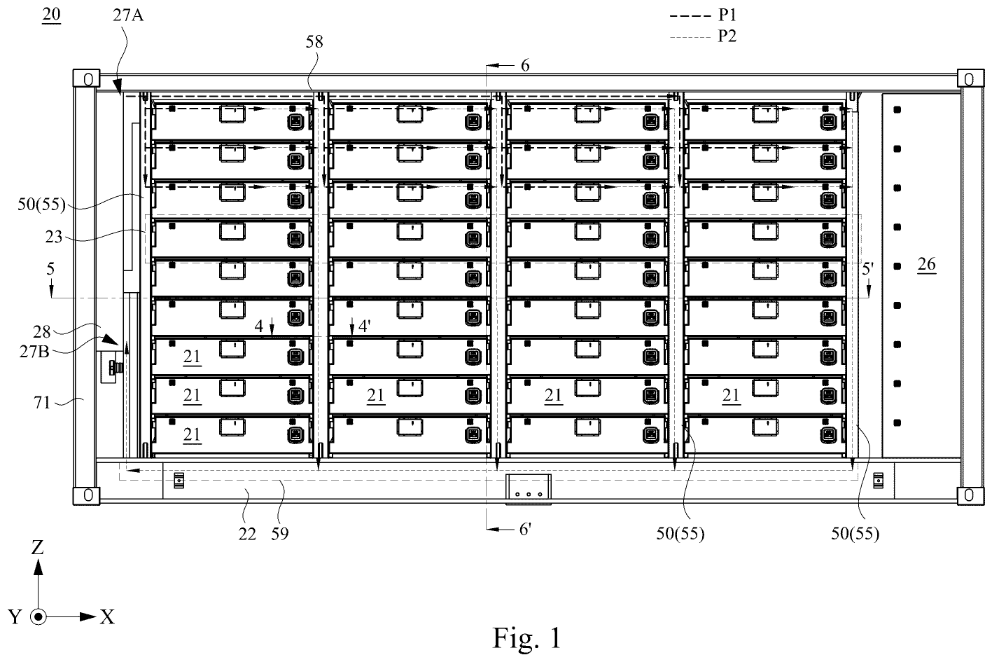

Reference is made to FIG. 1. FIG. 1 illustrates a side view of an energy storage cabinet 20 in accordance with an embodiment of the present disclosure. The energy storage cabinet 20 includes a frame 22 and one or more battery packs 21 disposed on the frame 22. The frame 22 is configured to support the battery packs 21. The frame 22 may have one or more slots, and each slot is configured to accommodate one of the battery packs 21. The battery packs 21 are removably disposed in the slots of the frame 22. In other words, the battery packs 21 can be inserted in the slots, and can be pulled out of the slots as needed (e.g., for the purpose of repair or maintenance). The frame 22 may include rail structures (not depicted in FIG. 1). The battery packs 21 may be engaged with rail structures of the frame 22, such that the battery packs 21 can be slid into or out of the slots. In some embodiments, the energy storage cabinet 20 may further include a plurality of door panels. The door panels cover laterals side of the frame 22 to isolate the battery packs 21 from the surrounding environment.

As shown in FIG. 1, the battery packs 21 are stacked along the vertical direction (e.g., along the Z direction). The battery packs 21 can be divided into multiple floor assemblies 23. Battery packs 21 with the same elevation belong to the same floor assembly 23. The battery packs 21 in the same floor assembly 23 may be arranged along the X direction. In the illustrated embodiment, the energy storage cabinet 20 includes nine floor assemblies 23, and one of which is identified by a dashed box. The battery packs 21 in the same floor assembly 23 are electrically connected in series, such that the voltages of the battery packs 21 in the same floor assembly 23 are summed up to produce a greater voltage. Each of the floor assemblies 23 may include a common anode and a common cathode.

As shown in FIG. 1, the energy storage cabinet 20 further includes a junction device 26. The junction device 26 is disposed on the frame 22 and is positioned on one side of the energy storage cabinet 20. The junction device 26 is connected to the common anode and the common cathode (not depicted) of each of the floor assemblies 23. The junction device 26 may include a DC junction unit, an AC auxiliary unit, and one or more control units (or one or more switch units).

As shown in FIG. 1, the energy storage cabinet 20 further includes at least one cooling device 28. The cooling device 28 is disposed on the frame 22 and is positioned on another side of the energy storage cabinet 20. The cooling device 28 is configured to produce a cool air, which can be supplied to the battery packs 21 to facilitate cooling of the battery packs 21. The cooling device 28 is, for example, an air conditioner. In some embodiments, the junction device 26 and the cooling device 28 are disposed on two opposite sides of the battery packs 21.

As shown in FIG. 1, the battery packs 21 are arranged into a plurality of stacks. The frame 22 of the energy storage cabinet 20 includes a plurality of supports 50 extending substantially vertically. Each of supports 50 can either be positioned between two adjacent stacks of the battery packs 21 or positioned on an outer side of the battery packs 21. In other words, the supports 50 and the multiples stacks of the battery packs 21 can be arranged in an interleaved manner. In some embodiments, each of the battery packs 21 is positioned between two supports 50.

As shown in FIG. 1, at least one of the supports 50 includes a pipe 55. The pipe 55 is a hollow structure and has an internal fluid passage. The internal fluid passage of the pipe 55 can communicate with the internal space of at least one of the battery packs 21 (e.g., a sidewall of the pipe 55 and a housing of the battery pack 21 can be have openings at corresponding positions). The frame 22 of the energy storage cabinet 20 further includes at least one cool air duct 58 and at least one warm air duct 59. In the illustrated embodiment, the cool air duct 58 extends above the battery packs 21, and the warm air duct 59 extends underneath the battery packs 21. The cool air duct 58 is connected to an upper end of at least one of the supports 50, and the warm air duct 59 is connected to a lower end of at least one of the supports 50. The internal fluid passage of the pipe 55 can communicate with the cool air duct 58 and the warm air duct 59 (the phrase “communicate with” used herein means “in fluid communication with”). The cooling device 28 is positioned on a lateral side of the battery packs 21. The cool air duct 58 and the warm air duct 59 extend substantially horizontally to the lateral side of the battery packs 21 and are connected to the cooling device 28. The cooling device 28 has a cool air output port 27A and a warm air input port 27B. In the illustrated embodiment, the cool air output port 27A and the warm air input port 27B are provided at an upper part and a lower part of the cooling device 28, respectively, and are connected to the cool air duct 58 and the warm air duct 59, respectively.

By this arrangement, the battery packs 21, the supports 50, the cool air duct 58, the warm air duct 59 and the cooling device 28 of the energy storage cabinet 20 of the present disclosure collectively form a small confined space. Airflow output by the cooling device 28 can be circulated in the small confined space to facilitate temperature control of the battery packs 21. On the other hand, conventional energy storage cabinets typically use air conditioner to control the temperature of the entire internal space of the cabinet. The conventional approach results in higher power consumption of the air conditioner, and moreover, requires the energy storage cabinet to be equipped with air conditioner of higher cooling capacity.

As shown in FIG. 1, the cool air produced by the cooling device 28 can flow along a first path P1. Specifically, the cool air can first flow along the cool air duct 58, and subsequently flow downward in the internal fluid passage of at least one of the supports 50, and subsequently enter the internal space of at least one of the battery packs 21 from one side of the battery packs 21. As the cool air passes through the battery packs 21, the cool air is heated and becomes a warm air. The warm air has a higher temperature than the cool air. The warm air can flow along a second path P2. Specifically, the warm air can exit the internal space of the battery packs 21 from another side of the battery packs 21, and subsequently flow downward in the internal fluid passage of at least one of the supports 50, and subsequently return to the cooling device 28 via the warm air duct 59.

It is noted that, in order to keep the lines of FIG. 1 simple and easy to read, FIG. 1 only schematically shows selective flow paths of the cool air and the warm air. The cool air and the warm air are not limited to these flow paths. In practice, the cool air can be supplied to any of the battery packs 21, and the warm air discharged from any of the battery packs 21 can be guided to flow back to the cooling device 28.

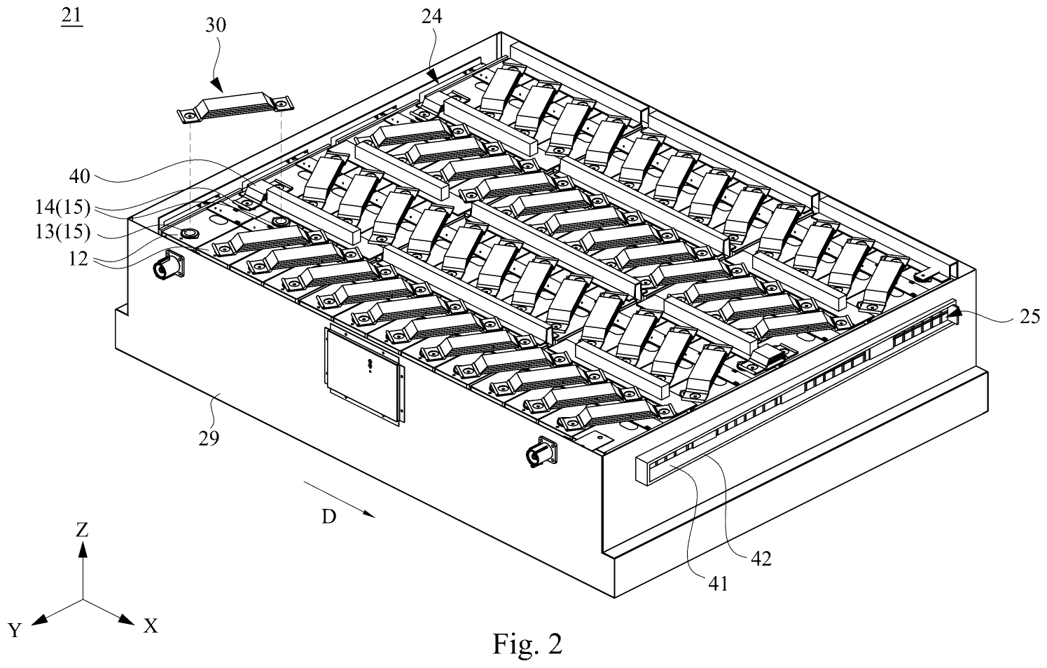

Reference is made to FIG. 2. FIG. 2 illustrates a schematic view of one of the battery packs 21 of the energy storage cabinet 20 shown in FIG. 1. In FIG. 2, a lid of the battery pack 21 is removed to reveal the interior of the battery pack 21. The battery pack 21 includes a housing 29 and a plurality of battery cells 12 disposed in the housing 29. The battery cells 12 are, for example, lithium-ion secondary batteries. The battery cells 12 may include prismatic cells or pouch type cells. The battery cells 12 are arranged in at least one row along a direction D.

As shown in FIG. 2, each of the battery cells 12 includes two electrode terminals 15 arranged side by side, one of which is a positive electrode 13 and the other is a negative electrode 14. The battery pack 21 further includes a plurality of first battery cell interconnection components 30, which may also be referred to as “busbars”. The first battery cell interconnection components 30 are disposed in the housing 29 and are configured to connect the battery cells 12 in series. Specifically, each of the first battery cell interconnection components 30 is electrically connected to the positive electrode 13 and the negative electrode 14 of two immediately adjacent battery cells 12 in the same row. In some embodiments, the battery pack 21 further includes at least one second battery cell interconnection component 40. The second battery cell interconnection component 40 is disposed in the housing 29 and is electrically connected to the electrode terminals 15 of two battery cells 12 on adjacent rows. The first battery cell interconnection components 30 and the second battery cell interconnection component 40 may include electrically conductive materials, such as copper or copper alloy.

As shown in FIG. 2, the housing 29 of the battery pack 21 has at least one air inlet 24 and at least one air outlet 25. The air inlet 24 and the air outlet 25 are provided on opposite sides of the housing 29, e.g., the air inlet 24 and the air outlet 25 may be vents/openings formed on two opposite sidewalls of the housing 29, respectively. The air inlet 24 and the air outlet 25 communicate with the internal fluid passage of the supports 50 shown in FIG. 1. The cool air produced by the cooling device 28 can flow into the internal fluid passage of the supports 50 and then enter the housing 29 through the air inlet 24. As the cool air passes through the battery pack 21, the cool air is heated and becomes a warm air. For example, the cool air has a lower temperature than one or more heat sources in the battery pack 21, such as the battery cells 12, the first battery cell interconnection components 30 and the second battery cell interconnection component 40, and thus the cool air can absorb heat from the one or more heat sources to facilitate cooling the battery pack 21. The warm air is then discharged into the internal fluid passage of the supports 50 via the air outlet 25.

In some embodiments, the energy storage cabinet 20 has a fire protection function to cope with the situation where some or all of the battery cells 12 fail and the temperature goes out of control or even causes fire. When the energy storage cabinet 20 detects overheating of at least one battery pack 21, the energy storage cabinet 20 is configured to fill a cooling liquid (e.g., pure water) into the housing 29 of the at least one overheating battery pack 21. In said situation, at least one of the air inlet 24 and the air outlet 25 can act as a discharge port for the battery pack 21 to discharge excessive cooling liquid.

As shown in FIG. 2, in some embodiments, the battery pack 21 further includes at least one first duct structure 41. The first duct structure 41 is disposed on the housing 29 and surrounds the air inlet 24 or the air outlet 25 of the housing 29. The first duct structure 41 projects from an outer wall of the housing 29. The first duct structure 41 may have at least one first sloping edge 42. In some embodiments, the battery pack 21 includes two first duct structures 41, one of which surrounds the air inlet 24 and the other surrounds the air outlet 25. The two first duct structures 41 may be arranged symmetrically.

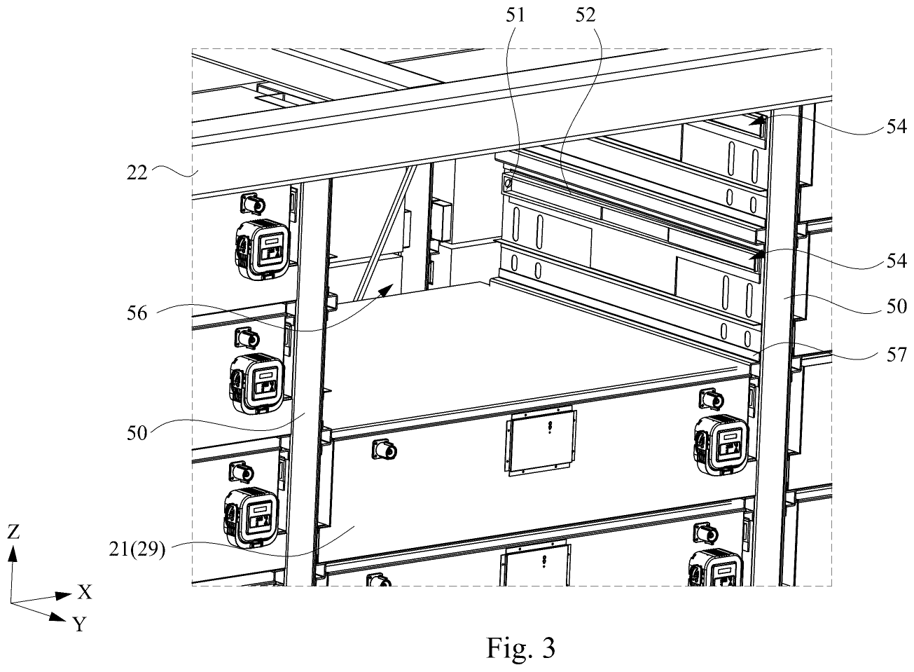

Reference is made to FIG. 3. FIG. 3 illustrates a partially enlarged view of the energy storage cabinet 20 shown in FIG. 1. As shown, two adjacent supports 50 of the frame 22 define multiple slots 56. The battery packs 21 are removably disposed in the slots 56. FIG. 3 shows some of the battery packs 21 being ejected from the slots 56. At least one of the supports 50 can include at least one guiding rail 57 disposed on a lateral surface of the supports 50. The guiding rail 57 is configured to detachably engage the housing 29 of the battery pack 21.

As shown in FIG. 3, the pipe 55 of at least one of the supports 50 has at least one side opening 54 communicating with the internal fluid passage of the pipe 55. Each side opening 54 faces and communicates with the air inlet 24 or the air outlet 25 of one of the battery packs 21. In some embodiments, at least one of the supports 50 further includes at least one second duct structure 51. Each second duct structure 51 is disposed on the pipe 55 and surrounds a respective side opening 54 of the pipe 55. The second duct structure 51 projects from an outer wall of the pipe 55 and is coupled to the first duct structure 41 of the battery pack 21 mentioned above. The second duct structure 51 may have at least one second sloping edge 52. The first sloping edge 42 of the first duct structure 41 mentioned above and the second sloping edge 52 of the second duct structure 51 have complementary shapes and abut against each other, such that the gap between the first duct structure 41 and the second duct structure 51 is minimized. With the first sloping edge 42 and the second sloping edge 52, the battery packs 21 can be smoothly inserted into or ejected from the slots 56.

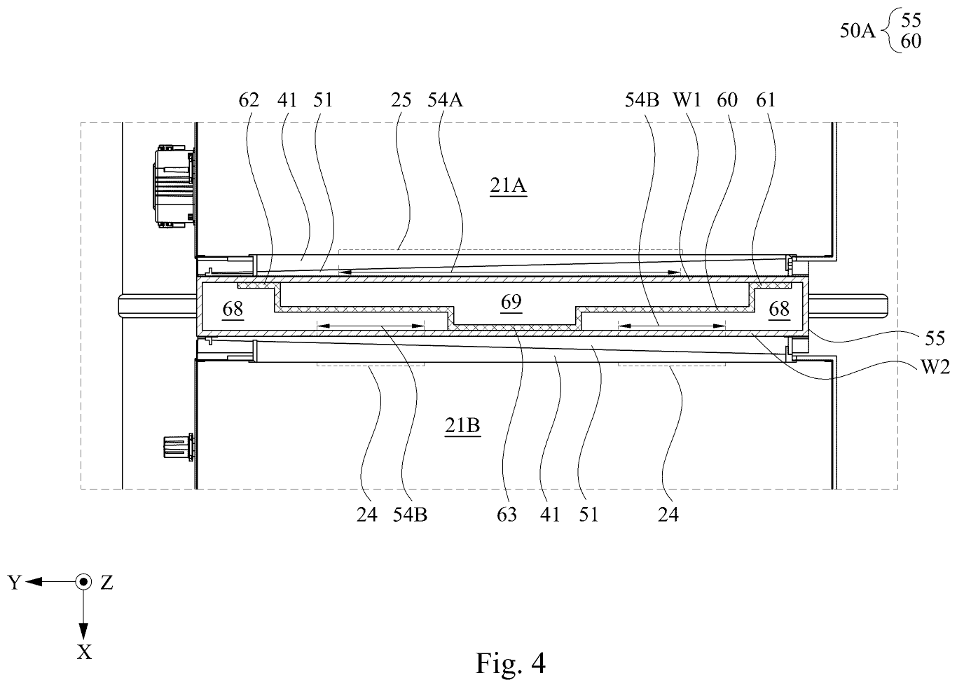

Reference is made to FIG. 4. FIG. 4 illustrates a sectional view of the energy storage cabinet 20 shown in FIG. 1 taken along the line segment 4-4′. As shown, the frame 22 includes a first support 50A. The first support 50A includes the pipe 55 described above, and further includes a partition 60. The partition 60 is disposed in the pipe 55 and divides the internal fluid passage of the pipe 55 into at least one cool air channel 68 and at least one warm air channel 69. The pipe 55 has at least one first side opening 54A and at least one second side opening 54B. The first side opening 54A and the second side opening 54B are located on two opposite sides of the partition 60 and communicate with the warm air channel 69 and the cool air channel 68, respectively. The battery packs 21 includes at least one first battery pack 21A and at least one second battery pack 21B positioned on two opposite sides of the first support 50A. The air outlet 25 of the first battery pack 21A communicates with the warm air channel 69 via the first side opening 54A of the pipe 55. The air inlet 24 of the second battery pack 21B communicates with the cool air channel 68 via the second side opening 54B of the pipe 55.

The cool air channel 68 is connected to the cool air duct 58 mentioned above to receive the cool air and deliver the cool air to the second battery pack 21B. The warm air channel 69 can receive the warm air discharged from the air outlet 25 of the first battery pack 21A. The warm air channel 69 is connected to the warm air duct 59 mentioned above, such that the warm air can return to the cooling device 28 mentioned above via the warm air duct 59. By providing the partition 60 in the pipe 55, the first support 50A can transport cool air and warm air at the same time and can prevent the warm air discharged from the first battery pack 21A from mixing with the cool air to be delivered to the second battery pack 21B behind the first battery pack 21A. This technique can help the cooling device 28 of the energy storage cabinet 20 save power, and can make the temperatures of the battery packs 21 of the energy storage cabinet 20 more uniform as well.

In some embodiments, the partition 60 extends from the upper end of the first support 50A (or the upper end of the pipe 55) to the lower end of the first support 50A (or the lower end of the pipe 55). The energy storage cabinet 20 may include a plurality of first battery packs 21A and a plurality of second battery packs 21B stacked along the first support 50A. The air outlet 25 of each of the first battery packs 21A communicates with the warm air channel 69 of the first support 50A, and the air inlet 24 of each of the second battery packs 21B communicates with the cool air channel 68 of the first support 50A. For example, the pipe 55 can have multiple first side openings 54A corresponding to the air outlets 25 of the multiple first battery packs 21A, and the pipe 55 can have multiple second side openings 54B corresponding to the air inlets 24 of the multiple second battery packs 21B. In other words, the cool air channel 68 of the first support 50A can distribute the cool air to a number of stacked battery packs 21, and the warm air channel 69 of the first support 50A can collect the warm air discharged from a number of stacked battery packs 21 and direct the warm air to the warm air duct 59 mentioned above (see the first path P1 along which the cool air flows and the second path P2 along which the warm air flows shown in FIG. 1).

As shown in FIG. 4, the partition 60 has two lateral edges 61 and 62 extending substantially vertically and fixedly attached to an inner wall of the pipe 55. The partition 60 further has a central portion 63 located between the two lateral edges 61 and 62. The central portion 63 may also be fixedly attached to the inner wall of the pipe 55 to increase the rigidity of the partition 60. The partition 60 is, for example, a metal sheet. The partition 60 can be affixed to the pipe 55 by soldering, screwing or other suitable means. The partition 60 may have a stepped shaped. Specifically, the partition 60 may be bent into a stepped shape between the central portion 63 and the two lateral edges 61 and 62.

As shown in FIG. 4, the inner wall of the pipe 55 has a first wall portion W1 and a second wall portion W2 opposite to the first wall portion W1. The two lateral edges 61 and 62 of the partition 60 can be fixedly attached to the first wall portion W1, and the central portion 63 of the partition 60 can be fixedly attached to the second wall portion W2. In some embodiments, the pipe 55 has two cool air channels 68 located on two sides of the central portion 63 of the partition 60, and the second battery pack 21B has two air inlets 24 communicating with the two cool air channels 68, respectively, via two different second side openings 54B of the pipe 55.

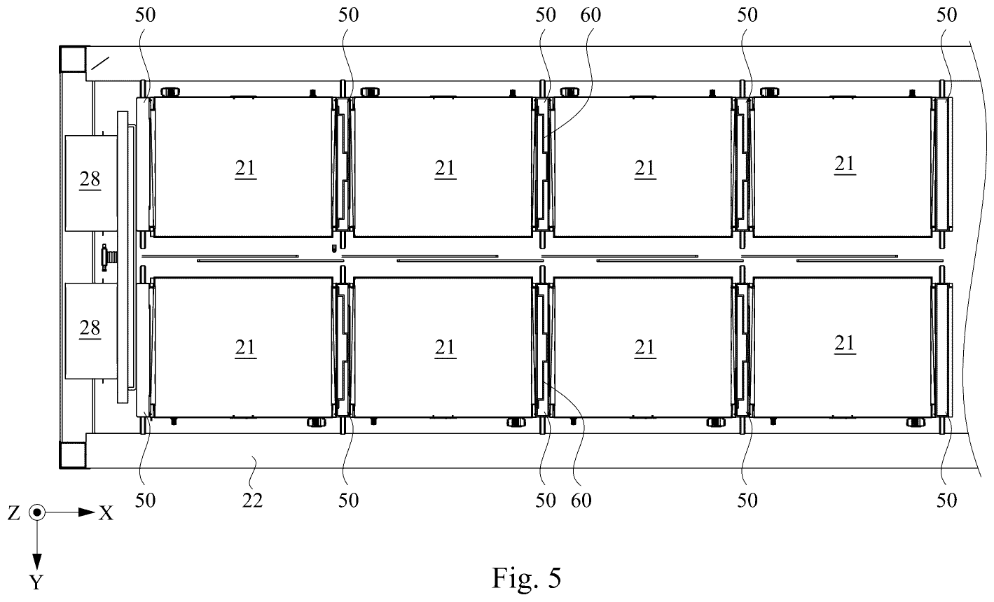

Reference is made to FIG. 5. FIG. 5 illustrates a sectional view of the energy storage cabinet 20 shown in FIG. 1 taken along the line segment 5-5′. As shown, any support 50 located between two battery packs 21 can include the partition 60, and any support 50 not located between two battery packs 21 does not necessarily have to include the partition 60. For example, the leftmost support 50 (the one closest to the cooling device 28) is only used to transport cool air and thus the partition 60 is not required. For example, the rightmost support 50 (the one farthest away from the cooling device 28) is only used to transport warm air and thus the partition 60 is not required.

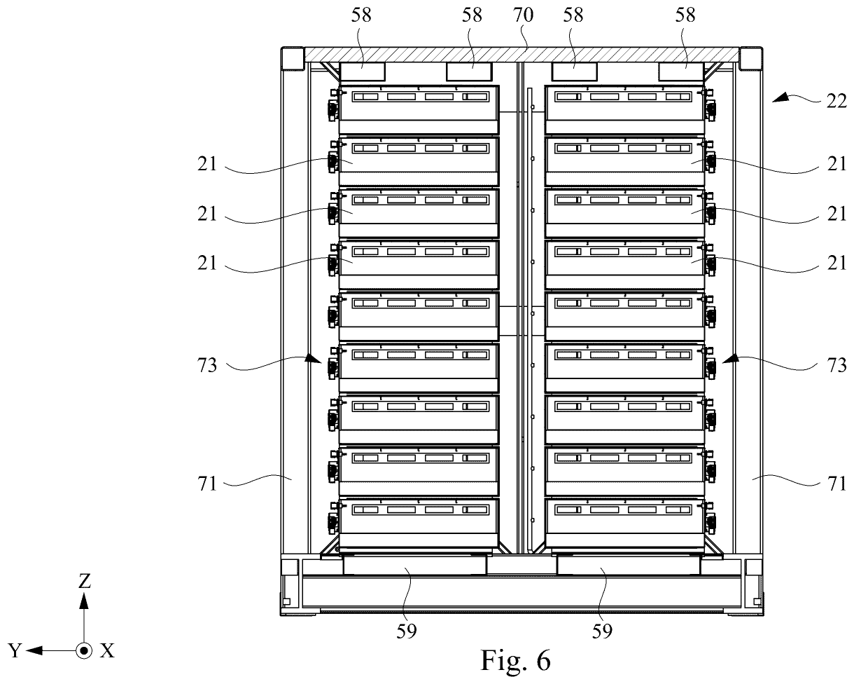

Reference is made to FIG. 6. FIG. 6 illustrates a sectional view of the energy storage cabinet 20 shown in FIG. 1 taken along the line segment 6-6′. As shown, in some embodiments, the energy storage cabinet 20 further includes a heat insulating member 70 disposed on the top of frame 22. The heat insulating member 70 covers an upper side of the battery packs 21 and an upper side of the cool air duct 58 to protect the battery packs 21 and the cool air duct 58 from sunlight. The heat insulating member 70 can include one of a liquid tank and a heat insulating plate. Alternatively, the heat insulating member 70 can include both a liquid tank and a heat insulating plate. For example, the liquid tank and the heat insulating plate may be provided in a stack arrangement. The liquid tank can store pure water or other suitable liquid. The liquid stored in the liquid tank can be used to implement the fire protection function mentioned above. The heat insulating plate may be formed of thermally insulating material.

As shown in FIG. 6, the frame 22 of the energy storage cabinet 20 further includes a plurality of main supports 71. The main supports 71 are positioned on the outer side the battery packs 21 and are spaced apart from the battery packs 21 to create ventilation spaces 73 to allow faster heat dissipation of the battery packs 21.

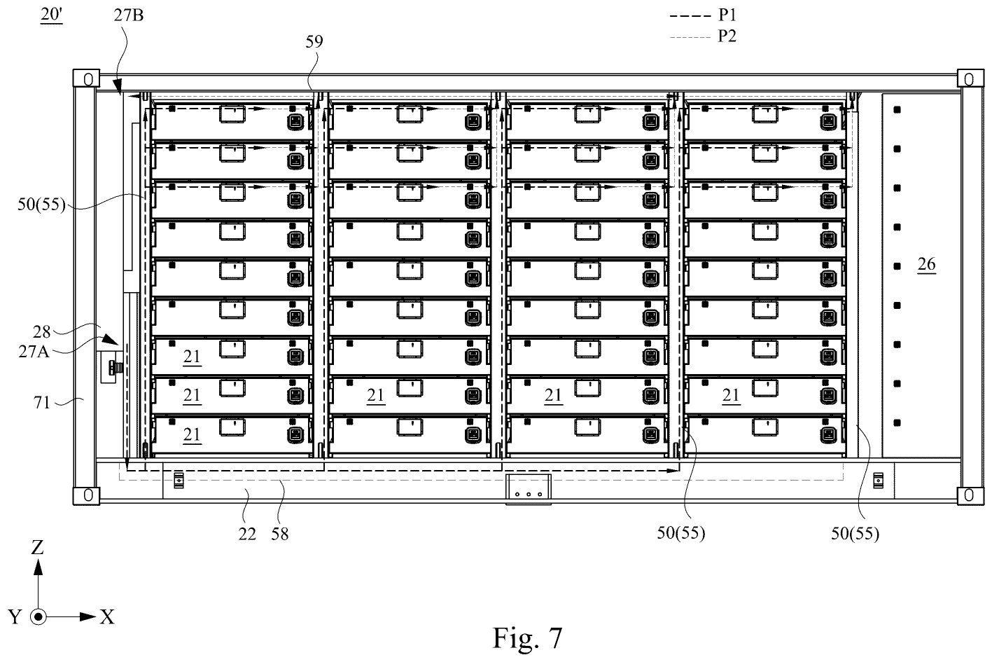

Reference is made to FIG. 7. FIG. 7 illustrates a side view of an energy storage cabinet 20′ in accordance with another embodiment of the present disclosure. In the present embodiment, the cool air duct 58 of the energy storage cabinet 20′ extends underneath the battery packs 21, and the warm air duct 59 of the energy storage cabinet 20′ extends above the battery packs 21. The cool air duct 58 is connected to a lower end of at least one of the supports 50, and the warm air duct 59 is connected to an upper end of at least one of the supports 50. The cool air output port 27A and the warm air input port 27B of the cooling device 28 are provided at a lower part and an upper part of the cooling device 28, respectively, and are connected to the cool air duct 58 and the warm air duct 59, respectively.

As shown in FIG. 7, the cool air produced by the cooling device 28 can flow along a first path P1. Specifically, the cool air can first flow along the cool air duct 58 underneath the battery packs 21, and subsequently flow upward in the internal fluid passage of at least one of the supports 50 (e.g., flow in the cool air channel mentioned above), and subsequently enter the internal space of at least one of the battery packs 21 from one side of the battery packs 21. As the cool air passes through the battery packs 21, the cool air is heated and becomes a warm air. The warm air has a higher temperature than the cool air. The warm air can flow along a second path P2. Specifically, the warm air can exit the internal space of the battery packs 21 from another side of the battery packs 21, and subsequently flow upward in the internal fluid passage of at least one of the supports 50, and subsequently return to the cooling device 28 via the warm air duct 59 above the battery packs 21.

In sum, in the energy storage cabinet of the present disclosure, one or more supports of the frame are hollow structures. The hollow supports can act as fluid passages and communicate with the internal space of the battery packs. The supports and the battery packs thus collectively form a small confined space. Airflow output by the cooling device of the energy storage cabinet can be circulated in the small confined space to facilitate temperature control of the battery packs. On the other hand, conventional energy storage cabinets typically use air conditioner to control the temperature of the entire internal space of the cabinet. The conventional approach results in higher power consumption of the air conditioner, and moreover, requires the energy storage cabinet to be equipped with air conditioner of higher cooling capacity. Furthermore, a partition is provided inside the support. The partition divides the internal fluid passage of the support into a cool air channel and a warm air channel, such that the support can transport cool air and warm air at the same time without mixing the cool air and the warm air. This technique can help the cooling device save power, and can make the temperatures of the battery packs of the energy storage cabinet more uniform as well.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. An energy storage cabinet, comprising:
a frame comprising a first support, the first support comprising a pipe and a partition, wherein the pipe has a first internal fluid passage, the partition is disposed in the pipe and divides the first internal fluid passage into at least one first flow channel and a second flow channel;
a plurality of battery packs disposed on the frame and each comprising a housing and a plurality of battery cells disposed in the housing, the housing having at least one first vent and a second vent, wherein the battery packs comprise at least one first battery pack and at least one second battery pack positioned on two opposite sides of the first support, the second vent of the at least one first battery pack communicates with the second flow channel, the at least one first vent of the at least one second battery pack communicates with the at least one first flow channel; and
a cooling device configured to produce a cool air, wherein the cool air is configured to enter the at least one first vent of the at least one first battery pack and the at least one first flow channel of the first support, and as the cool air passes through the at least one first battery pack, the cool air is heated and becomes a warm air, the warm air is then discharged into the second flow channel of the first support through the second vent of the at least one first battery pack.

2. The energy storage cabinet of claim 1, wherein the partition has two lateral edges and a central portion, the two lateral edges and the central portion are fixedly attached to an inner wall of the pipe.

3. The energy storage cabinet of claim 2, wherein the inner wall of the pipe has a first wall portion and a second wall portion opposite to the first wall portion, the two lateral edges of the partition are fixedly attached to the first wall portion, and the central portion of the partition is fixedly attached to the second wall portion.

4. The energy storage cabinet of claim 3, wherein the at least one first flow channel comprises two flow channels located on two sides of the central portion of the partition, wherein the at least one first vent of the at least one second battery pack comprises two vents communicating with the two flow channels, respectively.

5. The energy storage cabinet of claim 3, wherein the partition is bent into a stepped shape between the central portion and the two lateral edges.

6. The energy storage cabinet of claim 1, wherein the first support extends substantially vertically, the at least one first battery pack and the at least one second battery pack are plural in number and are stacked along the first support, the second vent of each of the first battery packs communicates with the second flow channel of the first support, and the at least one first vent of each of the second battery packs communicates with the at least one first flow channel of the first support.

7. The energy storage cabinet of claim 1, wherein the frame further comprises a second support and a cool air duct, the at least one first battery pack is positioned between the first support and the second support, the second support has a second internal fluid passage communicating with the at least one first vent of the at least one first battery pack, the cool air duct is connected to a cool air output port of the cooling device, the at least one first flow channel of the first support, and the second support.

8. The energy storage cabinet of claim 7, wherein the frame further comprises a third support and a warm air duct, the at least one second battery pack is positioned between the first support and the third support, the third support has a third internal fluid passage communicating with the second vent of the at least one second battery pack, the warm air duct is connected to a warm air input port of the cooling device, the second flow channel of the first support, and the third support to guide the warm air to return to the cooling device.

9. The energy storage cabinet of claim 8, wherein the battery packs are stacked along a vertical direction and are arranged into multiple stacks, one of the cool air duct and the warm air duct extends above the battery packs, and another one of the cool air duct and the warm air duct extends underneath the battery packs.

10. The energy storage cabinet of claim 9, wherein the cooling device is positioned on a lateral side of the battery packs, the cool air duct and the warm air duct extend substantially horizontally to the lateral side of the battery packs and are connected to the cooling device.

11. The energy storage cabinet of claim 1, wherein the at least one first battery pack further comprises a first duct structure surrounding the second vent, the pipe of the first support has a side opening communicating with the second flow channel, the first support further comprises a second duct structure surrounding the side opening and being coupled to the first duct structure, wherein the first duct structure has a first sloping edge, the second duct structure has a second sloping edge, the first sloping edge and the second sloping edge have complementary shapes and abut against each other.

12. The energy storage cabinet of claim 1, wherein the at least one second battery pack further comprises a first duct structure surrounding the at least one first vent, the pipe of the first support has a side opening communicating with the at least one first flow channel, the first support further comprises a second duct structure surrounding the side opening and being coupled to the first duct structure, wherein the first duct structure has a first sloping edge, the second duct structure has a second sloping edge, the first sloping edge and the second sloping edge have complementary shapes and abut against each other.

13. The energy storage cabinet of claim 1, further comprising a heat insulating member covering an upper side of the battery packs.

14. The energy storage cabinet of claim 13, wherein the heat insulating member comprises a liquid tank.

15. The energy storage cabinet of claim 13, wherein the heat insulating member comprises a heat insulating plate.

16. An energy storage cabinet, comprising:
a frame comprising a plurality of ducts;
a plurality of battery packs disposed on the frame and connected to the ducts;
a cooling device disposed on the frame and connected to the ducts,
wherein the cooling device is configured to produce a cool air, the cool air is circulated in the ducts and the battery packs to facilitate cooling of the battery packs; and
a liquid tank disposed on the frame, the liquid tank covering an upper side of the battery packs and part or all of the ducts.

17. The energy storage cabinet of claim 16, wherein the frame further comprises a plurality of main supports, the main supports are positioned on an outer side the battery packs and are spaced apart from the battery packs, such that ventilation spaces are created on the outer side of the battery packs.
